(19) United States
(12) Patent Application Publication
(10) Pub. No.: US 2025/0319969 A1
(43) Pub. Date: Oct. 16, 2025

(54) Stowable and Deployable Curtain Assembly

(71) Applicant: The Boeing Company, Arlington, VA (US)

(72) Inventors: Anthony E. Anderson, Snohomish, WA (US); Douglas Alan Brown, Edmonds, WA (US); Andrew William Mueller, Mukilteo, WA (US)

(21) Appl. No.: 19/173,172

(22) Filed: Apr. 8, 2025

Related U.S. Application Data
(60) Provisional application No. 63/634,154, filed on Apr. 15, 2024.

(51) Int. Cl. B64D 11/00

(52) U.S. Cl. CPC B64D 11/0023

(57) ABSTRACT

A curtain assembly includes: (i) a container having a top portion and a bottom portion, wherein the top and bottom portions are configured for being selectably disposed in a closed arrangement, in which the bottom portion cooperates with the top portion to define an interior of the container and to enclose the interior so as to form an enclosed volume within the container, and in an open arrangement, in which the bottom portion is moved away from the top portion to expose the interior so as to form an open volume within the container; (ii) a curtain track attached within the interior of the top portion, wherein the curtain track is disposed along an outer perimeter of the top portion; and (iii) a curtain configured for slidable attachment to the curtain track. An aircraft arrangement and method are also provided.

### RELATED APPLICATIONS

This application claims priority to U.S. Provisional Patent Application Ser. No. 63/634,154 filed on Apr. 15, 2024, which is incorporated herein by reference in its entirety.

### INTRODUCTION

This disclosure relates generally to stowable and deployable curtain assemblies.

An aircraft, such as a commercial passenger or cargo aircraft, may include one or more monuments aboard the aircraft. For example, a monument may include a functional unit such as a lavatory unit, a kitchen/galley unit or a stowage unit. Such aircraft monuments may be situated within the cabin between the cabin's outer wall and an aisle, or even between two aisles.

In some situations, it may be desirable to provide a curtain or other structure which temporarily and visually separates the monument from the rest of the cabin. For example, if the monument is a lavatory, it may be desirable to provide a curtain around the lavatory door in order to provide added privacy to the lavatory occupant, particularly if the occupant is constrained to a wheelchair.

### SUMMARY

According to one embodiment, a curtain assembly includes: (i) a container having a top portion and a bottom portion, wherein the top and bottom portions are configured for being selectively disposed in a closed arrangement, in which the bottom portion cooperates with the top portion to define an interior of the container and to enclose the interior so as to form an enclosed volume within the container, and in an open arrangement, in which the bottom portion is moved away from the top portion to expose the interior so as to form an open volume within the container; (ii) a curtain track attached within the interior of the top portion, wherein the curtain track is disposed along an outer perimeter of the top portion; and (iii) a curtain configured for slidable attachment to the curtain track.

The top portion may include a top wall, a front wall, a rear wall, a first side wall and a second side wall.

The curtain assembly may further include one or more wall attachment features disposed on one or both of the rear wall and the top wall for attachment of the top portion to one or both of an external vertical bulkhead and an external horizontal bulkhead, respectively.

The one or more wall attachment features may include one or both of male wall attachment features and female wall attachment features.

The curtain may include a plurality of curtain attachment features along a top edge of the curtain for slidably attaching the curtain to the curtain track. The curtain attachment features may include one or both of male curtain attachment features and female curtain attachment features.

The curtain assembly may be configured for being selectively disposed in a stowed arrangement, in which the container is disposed in the closed arrangement and the curtain is contained fully within the interior of the container, and in a deployed arrangement, in which the container is disposed in the open arrangement and the curtain is slidably attached to the curtain track.

In a first configuration, the bottom portion may be separable from the top portion, so as to dispose the container in the open arrangement, and engageable with the top portion, so as to dispose the container in the closed arrangement.

In a second configuration, the bottom portion may be attached to the first side wall of the top portion via a hinge, so as to permit the container to be disposed in the open arrangement, in which the bottom portion is pivoted away from the top portion so as to expose the interior of the container, and in the closed arrangement, in which the bottom portion is pivoted against the top portion so as to enclose the interior of the container. The second configuration may further include a latching mechanism for retaining the container in the closed arrangement, wherein the latching mechanism is disposed on one or both of the bottom portion and the second side wall of the top portion.

The front wall and the first and second side walls may form a generally U-shaped portion of the outer perimeter of the top portion, and wherein the curtain track is disposed along the generally U-shaped portion.

The external vertical bulkhead may include a monument aboard an aircraft.

The curtain may be slidably attached to the curtain track via the plurality of curtain attachment features.

According to another embodiment, a curtain assembly includes: (i) a container having a top portion and a bottom portion, wherein the top portion includes a top wall, a front wall, a rear wall, a first side wall and a second side wall, wherein the front wall and the first and second side walls form a generally U-shaped portion of an outer perimeter of the top portion and wherein the top and bottom portions are configured for being selectively disposed in a closed arrangement, in which the bottom portion cooperates with the top portion to define an interior of the container and to enclose the interior so as to form an enclosed volume within the container, and in an open arrangement, in which the bottom portion is moved away from the top portion to expose the interior so as to form an open volume within the container; (ii) a curtain track attached within the interior of the top portion, wherein the curtain track is disposed along the generally U-shaped portion of the outer perimeter of the top portion; and (iii) a curtain slidably attached to the curtain track via a plurality of curtain attachment features, wherein the curtain assembly is configured for being selectively disposed in a stowed arrangement, in which the container is disposed in the closed arrangement and the curtain is contained fully within the interior of the container, and in a deployed arrangement, in which the container is disposed in the open arrangement.

According to yet another embodiment, an aircraft arrangement includes an aircraft fuselage having an on-board monument, wherein the monument has a monument opening framed within a monument opening frame, and a curtain assembly. The curtain assembly includes: (i) a container having a top portion and a bottom portion, wherein the top and bottom portions are configured for being selectively disposed in a closed arrangement, in which the bottom portion cooperates with the top portion to define an interior of the container and to enclose the interior so as to form an enclosed volume within the container, and in an open arrangement, in which the bottom portion is moved away from the top portion to expose the interior so as to form an open volume within the container; (ii) a curtain track attached within the interior of the top portion, wherein the curtain track is disposed along an outer perimeter of the top portion; and (iii) a curtain configured for slidable attachment to the curtain track; (iv) wherein the top portion of the container includes a top wall, a front wall, a rear wall, a first side wall, a second side wall and one or more wall attachment features disposed on one or both of the rear wall and the top wall, wherein the one or more wall attachment features are attached to one or both of the monument opening frame and an external horizontal bulkhead adjacent the monument opening frame.

The curtain assembly may be configured for being selectively disposed in a stowed arrangement, in which the container is disposed in the closed arrangement and the curtain is contained fully within the interior of the container, and in a deployed arrangement, in which the container is disposed in the open arrangement and the curtain is slidably attached to the curtain track.

The front wall and the first and second side walls may form a generally U-shaped portion of the outer perimeter of the top portion, and wherein the curtain track is disposed along the generally U-shaped portion.

The curtain may include a plurality of curtain attachment features along a top edge of the curtain for slidably attaching the curtain to the curtain track.

The curtain assembly may be configured in either a first configuration or a second configuration. In the first configuration, the bottom portion may be separable from the top portion, so as to dispose the container in the open arrangement, and engageable with the top portion, so as to dispose the container in the closed arrangement. In the second configuration, the bottom portion may be attached to the first side wall of the top portion via a hinge, so as to permit the container to be disposed in the open arrangement, in which the bottom portion is pivoted away from the top portion so as to expose the interior of the container, and in the closed arrangement, in which the bottom portion is pivoted against the top portion so as to enclose the interior of the container.

According to a further embodiment, a method, includes: (A) providing a curtain assembly, wherein the curtain assembly includes: (i) a container having a top portion and a bottom portion, wherein the top and bottom portions are configured for being selectively disposed in a closed arrangement, in which the bottom portion cooperates with the top portion to define an interior of the container and to enclose the interior so as to form an enclosed volume within the container, and in an open arrangement, in which the bottom portion is moved away from the top portion to expose the interior so as to form an open volume within the container; (ii) a curtain track attached within the interior of the top portion, wherein the curtain track is disposed along an outer perimeter of the top portion; and (iii) a curtain configured for slidable attachment to the curtain track; (iv) wherein the top portion of the container includes a top wall, a front wall, a rear wall, a first side wall, a second side wall and one or more wall attachment features disposed on one or both of the rear wall and the top wall, wherein the one or more wall attachment features are configured for attachment to one or both of an external vertical bulkhead and an external horizontal bulkhead; and (B) attaching the curtain assembly to one or both of the external vertical and horizontal bulkheads via the one or more wall attachment features.

According to one embodiment, a curtain assembly is configured to be mounted within an interior space of a vehicle. The curtain assembly comprises a container comprising a first portion and a second portion wherein the first portion and the second portion are configured for being selectively disposed in a closed arrangement in which the second portion cooperates with the first portion to define an interior of the container and to enclose the interior so as to form an enclosed volume within the container, and in an open arrangement in which the second portion is moved away from the first portion to expose the interior so as to form an open volume within the container. A curtain track is attached to the first portion. A curtain is attached to the curtain track and positioned within the interior of the container in the closed arrangement and to extend outward beyond the first portion in the open arrangement.

The curtain assembly may include the first portion comprising a top wall, a front wall, a rear wall, a first side wall, and a second side wall.

The curtain assembly may include one or more wall attachment features disposed on one or both of the rear wall and the top wall to attach the first portion to the vehicle.

The curtain assembly may include that the one or more wall attachment features comprise one or both of male wall attachment features and female wall attachment features.

The curtain assembly may include the curtain with a plurality of curtain attachment features along a top edge to slidably attach the curtain to the curtain track.

The curtain assembly may include that the curtain attachment features comprise one or both of male curtain attachment features and female curtain attachment features.

The curtain assembly may be configured to be selectively disposed in a stowed arrangement and a deployed arrangement wherein the stowed arrangement comprises the container disposed in the closed arrangement and the curtain is contained fully within the interior of the container, and wherein the deployed arrangement comprises the container disposed in the open arrangement and the curtain extends from the first portion.

The curtain assembly may include that the first portion and the second portion are separate pieces with the second portion being attached to the first portion in the closed arrangement and detached from the first portion in the open arrangement.

The curtain assembly may include a hinge that connects the first portion to the second portion, wherein the hinge is configured to position the second portion in contact with the first portion in the closed arrangement and to position the second portion outward away from the first portion in the open arrangement.

The curtain assembly may include a stowage bag mounted to the second portion and sized to receive the curtain when the first portion and the second portion are in the closed arrangement.

According to one embodiment, an assembly comprises a monument configured to be mounted within a fuselage of a vehicle. A curtain assembly is mounted to the monument with the curtain assembly comprising: a container comprising a first portion and a second portion, wherein the first portion and second portion are configured for being selectively disposed in a closed arrangement and an open arrangement; a curtain track attached to the first portion; and a curtain attached to the curtain track and configured to slide along the curtain track. Wherein the curtain is positioned within the container in the closed arrangement, and extends outward from the container in the open arrangement to form a privacy area adjacent to the monument.

The assembly may include the curtain assembly mounted at a door of the monument and extends outward from the monument in front of the door.

The assembly may include the curtain assembly permanently mounted to the monument.

The assembly may include: one or more wall attachment features that are positioned on the curtain assembly; one or more receiving features that are positioned on the monument; and wherein the one or more wall attachment features are configured to engage with the one or more receiving features to mount the curtain assembly to the monument.

The assembly may include that the second portion cooperates with the first portion to define an enclosed interior space and wherein the curtain is positioned in the enclosed interior space in the closed arrangement.

The assembly may include a hinge that connects the first portion to the second portion, wherein the hinge maintains the first portion and the second portion connected together in the open arrangement.

The assembly may include a stowage bag mounted to the container and sized to receive the curtain.

According to one embodiment, a method of forming a privacy area within an interior space of a vehicle comprises: positioning the curtain assembly above a door of the monument with the monument positioned within the interior space of the vehicle; positioning a lower side of a container of the curtain assembly to face downward towards a floor of the interior space and enabling the container to be opened to deploy a curtain from within the container; and positioning a curtain track mounted to the container above and in front of the door and enabling the curtain to be extended along the curtain track to extend across a space that is in the front of the door.

The method may include mounting the curtain assembly to the monument so the curtain assembly can form a privacy area in front of the door when the curtain is deployed.

The method may include after deploying the curtain, removing the curtain assembly from the monument while the vehicle is moving.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is an exploded schematic diagram of an aircraft assembly that includes a monument and a curtain assembly.

FIG. 2 is an isometric view of an aircraft assembly with a curtain assembly in a stowed configuration.

FIG. 3 is an isometric view of the aircraft assembly of FIG. 2 with the curtain assembly in a deployed configuration.

FIG. 4 is a schematic top view of privacy spaced formed between the curtain and the monument.

FIG. 5 is a schematic section view of a container in a closed arrangement.

FIG. 6 is a schematic section view of the container of FIG. 5 in an open arrangement.

FIG. 7 is a bottom view of a container with wall attachment features that extend from a rear wall.

FIG. 8 is a schematic diagram of a section of a container having wall attachment features being connected to external receiving features.

FIG. 9 is a schematic section view of a container with a bottom portion that is hingedly connected to a top portion.

FIG. 10 is a schematic front view of a curtain of a curtain assembly.

FIG. 11 is an isometric view of an aircraft assembly with a container in an open arrangement and a curtain positioned in a bag of the container.

FIG. 12 is an isometric view of an aircraft assembly with a curtain positioned in a stowed orientation.

FIG. 13 is a flowchart diagram of a method of forming a privacy area within a cabin area of an aircraft.

FIG. 14 is an isometric view of an aircraft.

FIG. 15 is a schematic section view of a cabin area of an aircraft.

### DETAILED DESCRIPTION

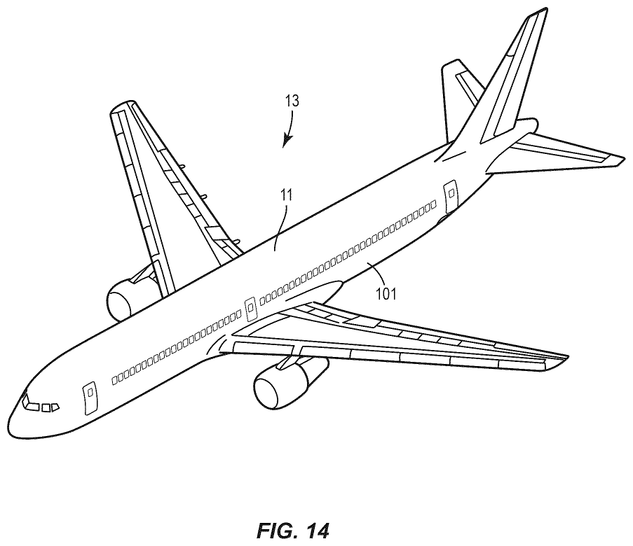

The curtain assembly 20 is configured to be mounted in a variety of different vehicles, such as but not limited to aircraft, trains, ships, buses. The curtain assembly 20 forms a privacy area for passengers, such as those that may need additional space. FIG. 14 illustrates an aircraft 13 which is one type of vehicle that is applicable for the curtain assembly 20. The aircraft 13 generally includes a fuselage 101 that includes a cabin area 11 configured to accommodate passengers.

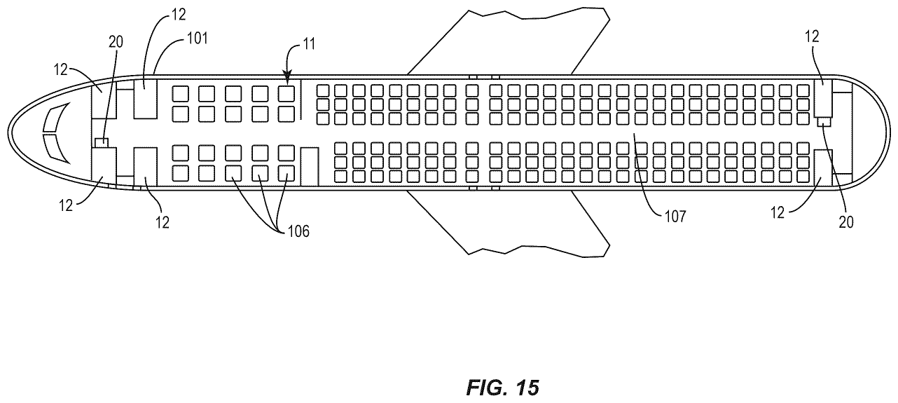

FIG. 15 illustrates an interior of the cabin area 11 that includes seats 106 positioned along one or more aisles 107. In some examples such as a commercial airline, the seats 106 extend throughout the cabin area 11. In other examples in which the aircraft 100 is used for cargo transport, a limited number of seats 106 are positioned in the cabin area 11. One or more monuments 12 are mounted to the structural members of the aircraft 100. The monuments 12 are functional units with examples including but not limited to galley workstations, lavatories, and stowage units. Curtain assemblies 20 are mounted to one or more of the monuments 12, such as to a lavatory monument 12.

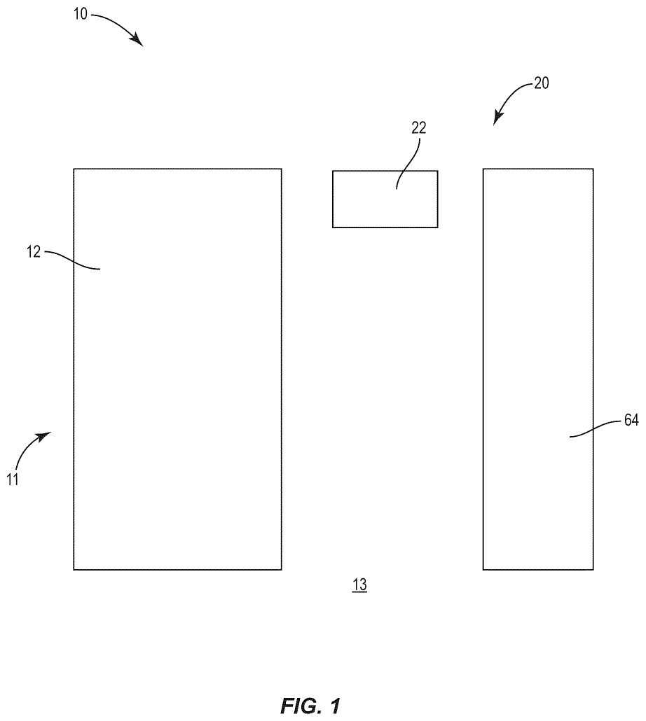

FIG. 1 schematically illustrates the curtain assembly 20 configured to mount to a monument 12 within an interior of an aircraft 13. In some embodiments, the monument 12 is a lavatory. Other embodiments include galleys, walls, and various others in which an enlarged privacy area is needed. The curtain assembly 20 is configured to be mounted to the monument 12 to form an aircraft assembly 10 configured to be positioned within a cabin area 11 of an aircraft 13. In some embodiments, the curtain assembly 20 is permanently mounted to the monument 12 such that it remains in position on the monument 12. In other embodiments, the curtain assembly 20 is removably mounted to the monument 12 and can be temporarily attached such as during use and then detached when not in use. In some embodiments, the removable curtain assembly 20 is configured to be used in two or more monuments within the aircraft 10.

The curtain assembly 20 includes a container 22 and a curtain 64. The container 22 is configured to connect to the monument 12 and to house the curtain 64 when not deployed. The curtain 64 is constructed from a flexible material sized to be moved around a portion of the monument 12, such as around a door of a lavatory. The curtain 64 is configured to be selectively moved between a stowage orientation that is housed within the container 22 and a deployed orientation to provide privacy to an area adjacent to the monument 12. The curtain 64 is further configured to be reusable such that it can be returned to the stowage orientation after use.

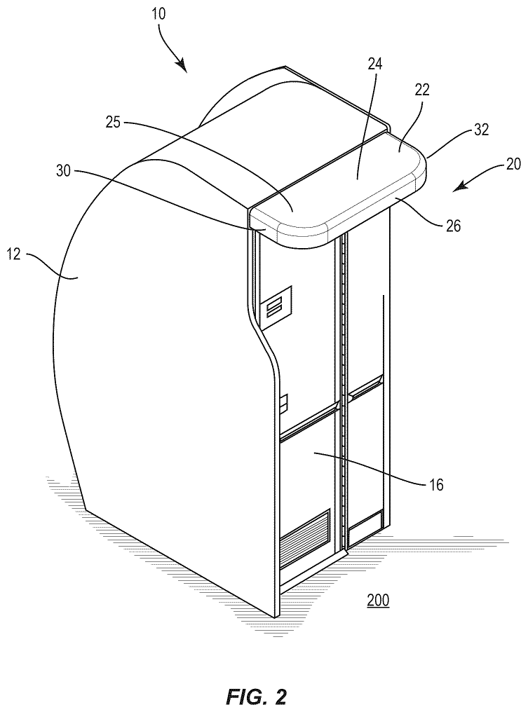

FIG. 2 illustrates an embodiment of the curtain assembly 20 positioned on the monument 12. In this embodiment, the curtain assembly 20 is mounted above and in front of a door 16 of a lavatory 12. FIG. 2 illustrates the curtain assembly 20 in a stowed orientation with a curtain (not illustrated in FIG. 2) positioned within the container 22. The curtain assembly 20 is positioned in a manner to not interfere with the opening and closing of the door 16 to allow the lavatory 12 to be used without deployed the curtain.

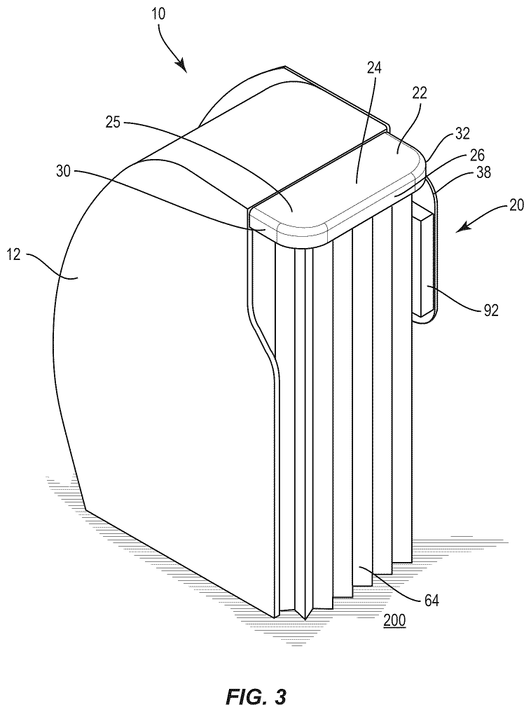

FIG. 3 illustrates the curtain assembly 20 in a deployed orientation. The curtain 64 has been removed from the container 22 and extends across and in front of the door 16. The curtain 64 is supported by an hangs downward from the container 22 in the deployed orientation. In some embodiments, the curtain 64 has a length to extend between and connect to the monument 12 on opposing sides of the door 16. The curtain 64 can include a height to extend between the container 22 and the floor 200 of the aircraft 10. In some embodiments, the curtain 64 forms a complete enclosure with no openings to enable privacy for a user. In other embodiments, the curtain 64 is sized for one or more openings to be formed between the monument 12 and/or floor 200.

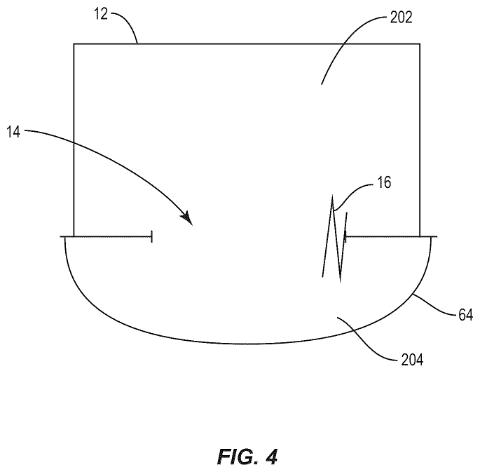

In the deployed orientation, the curtain assembly 20 creates a privacy area for a user that is adjacent to the monument 12. FIG. 4 schematically illustrates a privacy area 204 positioned at a monument 12. In some embodiments as illustrated, the privacy area 204 is formed at an opening 14 in the monument 12. When the door 16 of the monument 12 is in an open position as illustrated, the user is able to utilize the combined space formed by the privacy area 204 and the monument interior space 202. The privacy area 204 can include a variety of different shapes and sizes. In some embodiments, the privacy area 204 is sized to receive a wheelchair.

In some embodiments, the curtain assembly 20 is configured to mount to a monument 12. The curtain assembly 20 does not mount to other areas of the aircraft 10. This facilitates installation as just the monument 12 is affected without affecting other areas of the aircraft 10. In some embodiments, the curtain assembly 20 is configured to be installed on existing aircraft 10. Mounting to just the monument 12 facilitates this installation. In other embodiments, the curtain assembly 20 is installed during initial manufacturing of the aircraft 10.

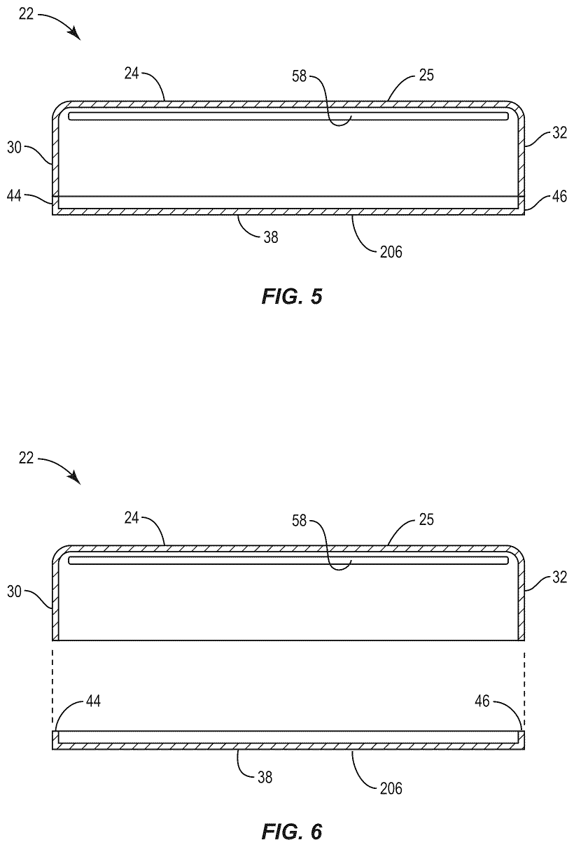

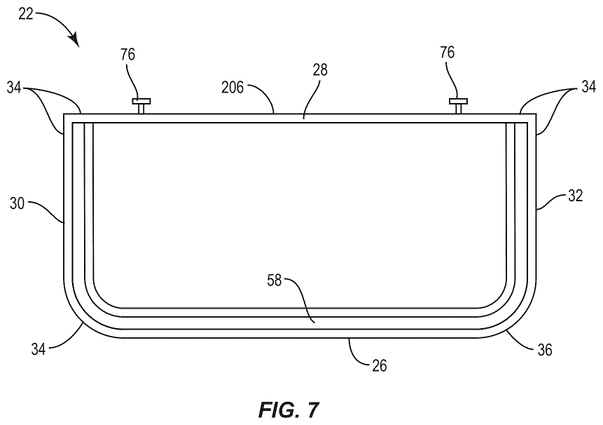

According to one embodiment as illustrated in FIG. 5, the curtain assembly 20 includes a container 22 having a top portion 24 and a bottom portion 38. The top and bottom portions 24, 38 are selectively moveable between a closed orientation and an open orientation. In some embodiments as illustrated in FIGS. 2, 3, and 5, the top portion 24 includes a top wall 25, a front wall 26, a rear wall (not illustrated), a first side wall 30 and a second side wall 32. The bottom portion 38 includes a bottom wall 206 and side walls 44, 46.

As illustrated in FIG. 5, the closed orientation includes the bottom portion 38 cooperating with the top portion 24 to define an interior 50. The interior space 50 has an enclosed volume 52 to contain the curtain (not illustrated in FIG. 5). In the open configuration as illustrated in FIG. 6, the bottom portion 38 is moved away from the top portion 24 to expose the interior 50 and form an open volume 56. The open configuration enables the curtain to be deployed.

The container 22 includes a curtain track 58 attached to the top portion 24 and located in the interior space 50. The curtain track 58 is disposed along a perimeter 34 of the top portion 24. The curtain track 58 is configured to connect to the curtain and enable the curtain to slide along the length.

In some embodiments, the front wall 26 and the first and second side walls 30, 32 form a generally U-shaped portion. The curtain track 58 is disposed along the generally U-shaped portion. The curtain track 58 may be secured to and within the top portion 24 at one or more different locations. The curtain track 58 may include, but is not limited to, a curtain rod or similar structure. In some embodiments, the curtain track 58 has a lower profile and takes up less space than a conventional curtain rod.

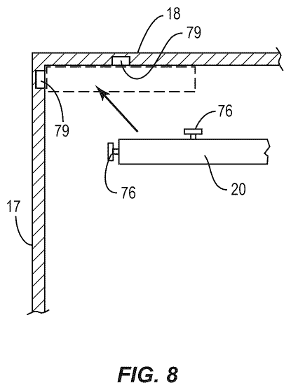

In some embodiments, the container 22 is permanently connected to the monument 12. In some embodiments, the container 22 is connected with mechanical fasteners such as but not limited to screws, bolts, and rivets. Additionally or alternatively, one or more wall attachment features 76 are disposed on one or both of the rear wall 28 and the top wall 25. The wall attachment features 76 may include one or both of male wall attachment features 78 and female wall attachment features 80. In some embodiments, the attachment features include male features such as lugs, hooks, extensions, and studs and/or female features such as holes and eyelets. The attachment features 80 can provide for permanent attachment of the container 22, or can provide for temporary attachment as the attachment features 80 can be disconnected. In some embodiments, the attachment features 80 are on the monument 12. Additionally or alternatively, the attachment features 80 engage with other sections of the aircraft 10 such as but not limited to one or more bulkheads. FIG. 8 illustrates an embodiment of portion of a container 22 having wall attachment features 76. The wall attachment features 76 are shaped and positioned to mate with corresponding attachment features 79. In some embodiments, the attachment features 79 are positioned in the monument 12. In other embodiments, the attachment features 79 are positioned on the aircraft 10, such as along one or more bulkheads 17, 18.

The container 22 is configured to be positioned between a closed position in which the top portion 24 and the bottom portion 38 are connected together to contain the curtain 64, and an open position in which the curtain 64 can be deployed. In some embodiments, the top portion 24 and the bottom portion 38 separate in the open position. In some embodiments as illustrated in FIGS. 5 and 6, the top portion 24 and the bottom portion 38 are independent separate pieces that enable them to be detached and separated. In some embodiments, the bottom portion 38 is removed from the top portion 24 by flight personnel when using the curtain assembly 20 for a passenger. The two portions 24, 38 can be connected together in various manners, such as but not limited to one or more of a friction fit, mechanical fasteners, and straps/connectors.

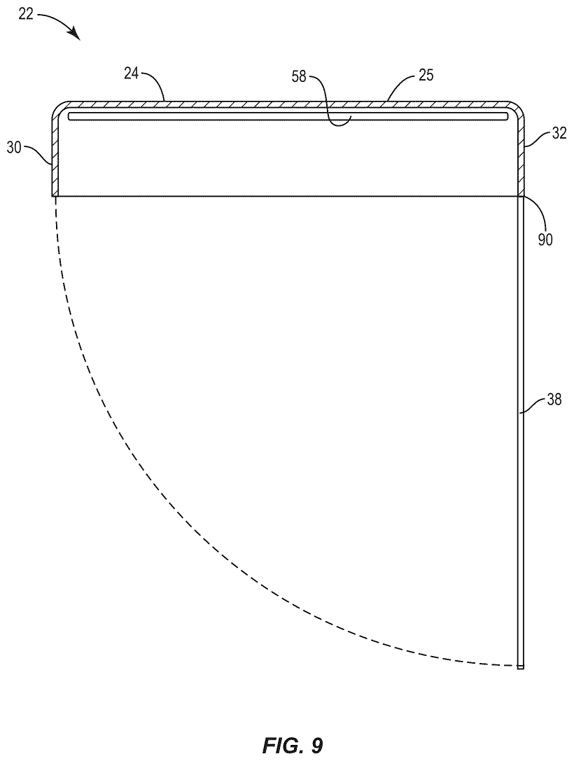

In other embodiments, the top portion 24 and the bottom portion 38 remain connected together in both the open position and the closed position. The bottom portion 38 is attached to the top portion 24, such as at one of the first and second side walls 30, 32. The connection enables the bottom portion 38 to be moved between the closed position and the open position. In some embodiments as illustrated in FIG. 9, a hinge 90 connects the bottom portion 38 to the top portion 24. The hinge 90 can include various configurations such as an integrated or living hinge, a mechanical hinge, etc. The hinge 90 enables the bottom portion 38 to be pivoted away from the top portion 24 to expose the interior 50 of the container 22, and in the closed arrangement 48, in which the bottom portion 38 is pivoted against the top portion 24. The second configuration 86 may further include a latching mechanism 94 for retaining the container 22 in the closed arrangement 48, wherein the latching mechanism 94 is disposed on one or both of the bottom portion 38 and the first or second side wall 30, 32 of the top portion 24.

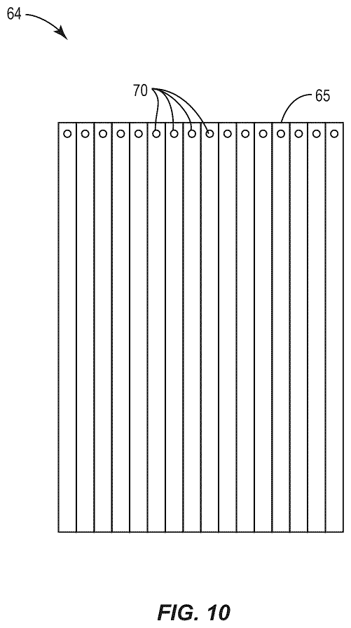

The curtain 64 may be made of fabric, plastic or other suitable materials. The curtain 64 is opaque to provide privacy for a person that is using the curtain assembly 20. As illustrated in FIG. 10, the curtain 64 is slidably attached to the curtain track 58 via curtain attachment features 70 along a top edge 65. The curtain attachment features 70 may include one or both of male features such as hooks 72 that extend upward and outward from the top edge 65 and female features such as eyelets and grommets.

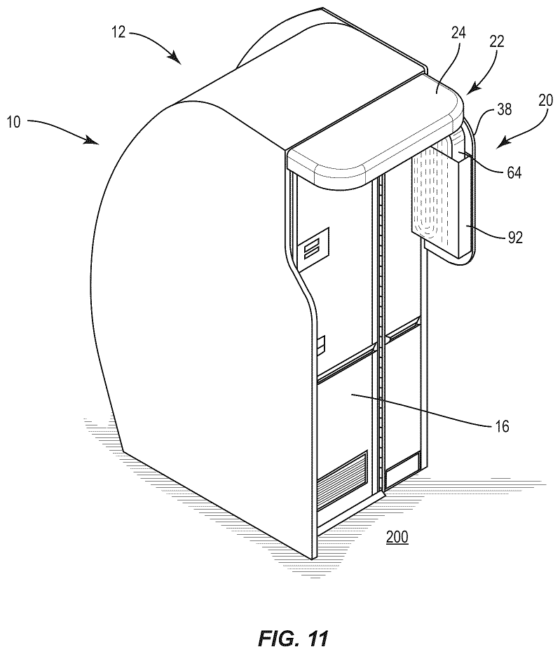

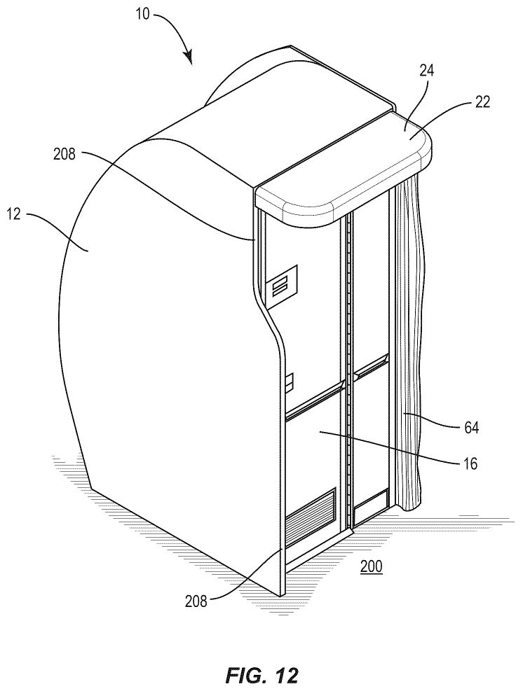

The bottom portion 38 supports the curtain 64 when the bottom portion 38 is connected to the top portion 24. In some embodiments, the bottom portion 38 does not support the curtain 64 when the bottom portion 38 is opened, such as when the bottom portion 38 is detached from the top portion 24. In other embodiments, the bottom portion 38 supports the curtain when opened. FIG. 11 illustrates an embodiment with the bottom portion 38 in an open position and supporting the curtain 64. A stowage bag 92 is mounted to the bottom portion 38. The curtain 64 is folded in a stowed position and stored in the stowage bag 92. When the bottom portion 38 is opened, the curtain 64 is removed from the bag 92 and deployed. Further, the curtain 64 is housed in the stowage bag 92 when the container 22 is in the closed position. In some examples, the stowage bag 92 is flexible to facilitate insertion of the curtain 64. In other examples, the stowage bag 92 is rigid and provides additional protection for the curtain 64.

FIG. 12 illustrates an embodiment in which the curtain 64 is not contained in the container 22 in the stowed position. Rather, the curtain 64 extends downward from the top portion 24 in the stowed position. The curtain 64 is mounted on the curtain track (not illustrated in FIG. 12). The curtain 64 is positioned to enable a person to move through the door 16. In some embodiments, the curtain 64 is secured away from the door 16, such as by a belt, cord, or other like fastener.

To deploy the curtain 64, the curtain 64 is extended along the curtain track to form the privacy area (similar to the arrangement illustrated in FIG. 3). This can include flight personnel grasping the exposed edge and pulling the curtain 64 along the curtain track. In some embodiments, one or more fasteners 208 secure the back edge of the curtain 64 to the monument 12. This ensures that there are no openings formed between the monument 12 and the back edge of the curtain 64 when the curtain is deployed along the curtain track.

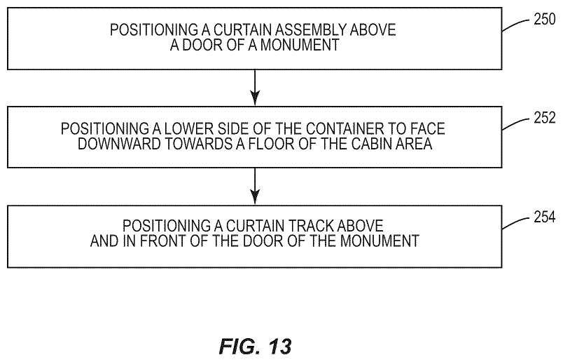

FIG. 13 illustrates a method of forming a privacy area 204 within a cabin area 11 of an aircraft 13. The method includes positioning a curtain assembly 20 above a door 16 of the monument 12 (block 250). The monument 12 is positioned within the cabin area 11 of an aircraft 13. A lower side of the container 22 of the curtain assembly 20 is positioned to face downward towards a floor of the cabin area (block 252). This positioning enables the container 22 to be opened to deploy a curtain 64 from within the container 22. A curtain track 58 mounted to the container 22 is positioned above and in front of the door 16 (block 254). This positioning enables the curtain 64 to be extended along the curtain track 58 to extend across a space that is in the front of the door 16 and form a privacy area 204.

In some embodiments, the curtain assembly 20 is mounted to the monument 12 so the privacy area 204 is formed in front of the door 16 of the monument 12. In other embodiments, the curtain assembly 20 is positioned at other locations to form the privacy area in other places in the cabin area 11 of the aircraft 13.

In some embodiments, the curtain assembly 20 is permanently mounted the monument 12. This enables the curtain assembly 20 to remain in position and be used at the location during each of the flights of the aircraft 13. In other embodiments, the curtain assembly 20 is removed from the monument 12 after use. The curtain assembly 20 can be stored and then re-used either at that same monument 12 or at other monuments or locations in the aircraft 13.

According to a further embodiment, a method includes: providing a curtain assembly, wherein the curtain assembly includes: (i) a container having a top portion and a bottom portion, wherein the top and bottom portions are configured for being selectably disposed in a closed arrangement, in which the bottom portion cooperates with the top portion to define an interior of the container and to enclose the interior so as to form an enclosed volume within the container, and in an open arrangement, in which the bottom portion is moved away from the top portion to expose the interior so as to form an open volume within the container; (ii) a curtain track attached within the interior of the top portion, wherein the curtain track is disposed along an outer perimeter of the top portion; and (iii) a curtain configured for slidable attachment to the curtain track; (iv) wherein the top portion of the container includes a top wall, a front wall, a rear wall, a first side wall, a second side wall and one or more wall attachment features disposed on one or both of the rear wall and the top wall, wherein the one or more wall attachment features are configured for attachment to one or both of an external vertical bulkhead and an external horizontal bulkhead; and attaching the curtain assembly to one or both of the external vertical and horizontal bulkheads via the one or more wall attachment features. The method may further include: disposing the curtain assembly in the open arrangement; at step 140, attaching the curtain to the curtain track (if not already attached); opening the curtain along the generally U-shaped portion of the curtain track; closing the curtain; disposing the curtain assembly in the closed arrangement; removing the curtain assembly from the external vertical/horizontal bulkhead(s).

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A curtain assembly to be mounted within an interior space of a vehicle, the curtain assembly comprising:
a container comprising a first portion and a second portion, wherein the first portion and the second portion are configured for being selectively disposed in a closed arrangement, in which the second portion cooperates with the first portion to define an interior of the container and to enclose the interior to form an enclosed volume within the container, and in an open arrangement, in which the second portion 38 is moved away from the first portion to expose the interior to form an open volume within the container;
a curtain track attached to the first portion; and
a curtain attached to the curtain track and positioned within the interior of the container in the closed arrangement and to extend outward beyond the first portion in the open arrangement.

2. The curtain assembly of claim 1, wherein the first portion comprises a top wall, a front wall, a rear wall, a first side wall and a second side wall.

3. The curtain assembly of claim 2, further comprising one or more wall attachment features disposed on one or both of the rear wall and the top wall to attach the first portion to the vehicle.

4. The curtain assembly of claim 3, wherein the one or more wall attachment features comprise one or both of male wall attachment features and female wall attachment features.

5. The curtain assembly of claim 1, wherein the curtain comprises a plurality of curtain attachment features along a top edge to slidably attach the curtain to the curtain track.

6. The curtain assembly of claim 5, wherein the curtain attachment features comprise one or both of male curtain attachment features and female curtain attachment features.

7. The curtain assembly of claim 1, wherein the curtain assembly is configured to be selectively disposed in a stowed arrangement and a deployed arrangement;
wherein the stowed arrangement comprises the container disposed in the closed arrangement and the curtain is contained fully within the interior of the container; and
wherein the deployed arrangement comprises the container disposed in the open arrangement and the curtain extends from the first portion.

8. The curtain assembly of claim 1, wherein the first portion and the second portion are separate pieces with the second portion being attached to the first portion in the closed arrangement and detached from the first portion in the open arrangement.

9. The curtain assembly of claim 2, further comprising a hinge that connects the first portion to the second portion, wherein the hinge is configured to position the second portion in contact with the first portion in the closed arrangement and to position the second portion outward away from the first portion in the open arrangement.

10. The curtain assembly of claim 1, further comprising a stowage bag mounted to the second portion and sized to receive the curtain when the first portion and the second portion are in the closed arrangement.

11. An assembly, comprising:
a monument configured to be mounted within a fuselage of a vehicle; and
a curtain assembly mounted to the monument, the curtain assembly comprising:
a container comprising a first portion and a second portion, wherein the first portion and second portion are configured for being selectively disposed in a closed arrangement and an open arrangement;
a curtain track attached to the first portion; and
a curtain attached to the curtain track and configured to slide along the curtain track;
wherein the curtain is positioned within the container in the closed arrangement, and extends outward from the container in the open arrangement to form a privacy area adjacent to the monument.

12. The assembly of claim 11, wherein the curtain assembly is mounted at a door of the monument and extends outward from the monument in front of the door.

13. The assembly of claim 11, wherein the curtain assembly is permanently mounted to the monument.

14. The assembly of claim 11, further comprising:
one or more wall attachment features that are positioned on the curtain assembly;
one or more receiving features that are positioned on the monument; and
wherein the one or more wall attachment features are configured to engage with the one or more receiving features to mount the curtain assembly to the monument.

15. The assembly of claim 11, wherein the second portion cooperates with the first portion to define an enclosed interior space and wherein the curtain is positioned in the enclosed interior space in the closed arrangement.

16. The assembly of claim 11, further comprising a hinge that connects the first portion to the second portion, wherein the hinge maintains the first portion and the second portion connected together in the open arrangement.

17. The assembly of claim 11, further comprising a stowage bag mounted to the container and sized to receive the curtain.

18. A method of forming a privacy area within an interior space of a vehicle, the method comprising:
positioning a curtain assembly above a door of a monument with the monument positioned within the interior space of the vehicle;
positioning a lower side of a container of the curtain assembly to face downward towards a floor of the interior space and enabling the container to be opened to deploy a curtain from within the container; and
positioning a curtain track mounted to the container above and in front of the door and enabling the curtain to be extended along the curtain track to extend across a space that is in the front of the door.

19. The method of claim 18, further comprising mounting the curtain assembly to the monument so the curtain assembly can form a privacy area in front of the door when the curtain is deployed.

20. The method of claim 18, further comprising after deploying the curtain, removing the curtain assembly from the monument while the vehicle is moving.
